(19) United States
(12) Patent Application Publication
(10) Pub. No.: US 2005/0146294 A1
(43) Pub. Date: Jul. 7, 2005

(54) Electronic device for delivering yarn to textile machines

(76) Inventor: Filippo Oneda, Brescia (IT)

Correspondence Address: HEDMAN & COSTIGAN P.C., 1185 AVENUE OF THE AMERICAS, NEW YORK, NY, 10036, US

(21) Appl. No.: 10/706,681

(22) Filed: Nov. 12, 2003

(30) Foreign Application Priority Data
Jun. 18, 2003 (IT) VI2003A 000117

(51) Int. Cl. H02P 5/46

(52) U.S. Cl. 318/85

(57) ABSTRACT

An electronic device for delivering yarn to textile machines comprising a motor (1), and an electronic control board (2), which includes a microcontroller, able to control the rotating speed of the motor (1) and the currents in the phases of said motor (1); the device has the purpose of adjusting the delivery of each thread (11), by varying the rotating speed of the motor (1), so as to maintain it as synchronised as possible, according to an adjustable scale factor, with the speed of the textile machine served; the device also stops and starts up when the machine is working, so that the rotating speed of the motor (1) is synchronised with the motion of the thread-tighteners (if textile machines equipped with striping devices having a set of thread-tightener for each knitting station are provided, in which a set of threads of different colours and materials are provided at each drop, according to a prefixed and programmed sequence).

The present invention refers to an electronic device for delivering yarn to textile machines.

Yarn-feed reels of a textile machine are usually set on the top frame of the machine or on a side reel-frame; in this arrangement, the side reel-frame occupies more space, but enables an increase in the number of yarn feeds, the possibility of resorting to double feed at each drop and the possibility of changing the empty reels more easily and rapidly.

On textile machines with rotating skirts, the reel frame is fixed to, and set in continuous rotation with, the skirts themselves.

In any case, prior to arriving at the needles, the yarn follows a rather long path, to give the machine time to stop before a possible broken end gets caught up.

On the most recent circular machines for hosiery, control of the feed is extremely important; for this reason, positive feeders can be used, which release to the needles a length of yarn that is as constant as possible in time, or accumulation feeders are provided, which maintain the tension of the yarn as constant as possible.

The positive feeder most widely used at the moment is the ribbon feeder, whereby a ribbon runs all around the circumference of the machine, at each drop; the yarn acquires the speed of the ribbon, so as to obtain a more uniform fabric, regulating the absorption on all the drops with just one operation in so far as, necessarily, all the threads of yarn are fed the individual drops at the same speed.

Alternatively, control of the positive feeders of the yarn can be obtained by means of interchangeable gears located in a special gear-case and by expandable pulleys with manual adjustment.

Adjustment of the expandable pulleys is carried out by slackening a belt, using a belt-tensioner, and then by releasing a ring nut using a pin provided so as to gain access to the plate of the pulley; it is thus possible to adjust the diameter by rotating the aforementioned plate of the pulley, which is provided with reference marks and finally to re-tighten the ring nut.

Upon request, further gears are available for different feeds of the yarn and arrangements of the textile machines to accept one-way or multiple-way positive heads, as well as different sizes of the belts.

However, the drawbacks deriving from using similar devices are known; in particular, it is not possible to obtain (and to program) a predetermined ratio of synchronism between the delivery speed of yarn and the peripheral speed of the main cylinder of the textile machine; moreover, the use of transmission belts forces each device to be maintained in fixed positions over the circumference of the textile machine and does not allow an easy and quick identification of the position of the drop in which breaking of the yarn occurs in the event of faults of the machine.

A purpose of the present invention is therefore to overcome the drawbacks mentioned and in particular to provide an electronic device for delivering yarn to textile machines, which enables adjustment of the delivery of yarn by varying the speed of a d.c. motor so as to keep it as synchronised as possible, according to an adjustable scale factor, with the speed of the textile machine served.

Another purpose of the present invention is to provide an electronic device for delivering yarn to textile machines, which enables programming of suitable unwinding values for each thread, so as to obtain a process flexibility, unlike the traditional systems. Another purpose of the invention is to provide an electronic device for delivering yarn to textile machines, which is able to identify the position of the broken thread in the event of breaking of the yarn.

A further purpose of the present invention is to provide an electronic device for delivering yarn to textile machines which does not involve the use of transmission belts, so that each device can be fixed in different positions from those attached to the circumference of the cylinder of the machine.

A further purpose of the present invention is to provide an electronic device for delivering yarn to textile machines which is able to stop and to start up, even when the textile machine is working, in synchronism with the functioning of the thread-tighteners of the machine, in case of textile machines having striping devices with many thread-tighteners for each stitching station, which are able to deliver threads of different colours or materials for each drop according to a prefixed and programmable sequence, are used.

Another purpose of the invention is to provide an electronic device for delivering yarn to textile machines, which does not involve the use of complex technologies and which enables substantial reduction of processing times and of losses in productivity losses, as compared to known techniques by managing the production processes in a more appropriate way.

The above and other purposes are achieved by an electronic device for delivering yarn to textile machines according to claim 1, to which the reader is referred for reasons of brevity.

Advantageously, each supply reel or bobbin of each single thread to deliver to the textile machine is equipped with a motor, which is controlled by an electronic control board, so as to keep synchronism between the speed of delivering of each thread and the speed of rotation of the cylinder of the textile machine.

The system, therefore, is able to feed the thread from a single feed point (knitted thread) of the machine, so as to enable adjustment and programming a synchronism ratio between the speed of the motor of each reel and the speed of the textile machine.

Application of said electronic device for each knitted thread of the textile machine also enables adjustment and programming a prefixed value of thread unwinding, for each thread, so as to obtain a suitable processing flexibility.

Moreover, in the event of breaking of a single thread, it is possible, through serial communication, to identify which electronic device has detected the error (i.e. the breaking); the above also allows for speeding up times for searching errors (the broken threads) and moreover the possibility of reprogramming a synchronism ratio while the textile machine is working enables knitting effects that cannot be obtained with other traditional systems.

Further purposes and advantages of the present invention will emerge clearly from the ensuing description and from the attached schematic drawings, which are provided purely by way of explanatory and non-limiting example of embodiment, in which:

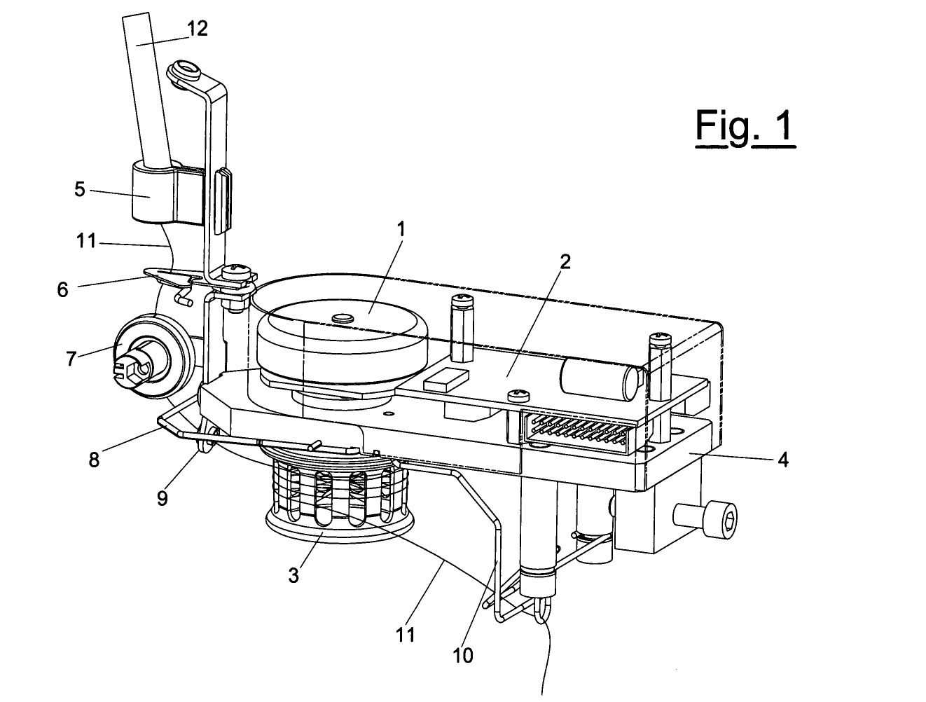

FIG. 1 shows schematic perspective view of an electronic device for delivering yarn to textile machines, according to the present invention;

FIG. 1A shows a schematic sectional view of an electronic device for delivering yarn to textile machines, according to an alternative embodiment of the invention with respect to the embodiment showed in FIG. 1;

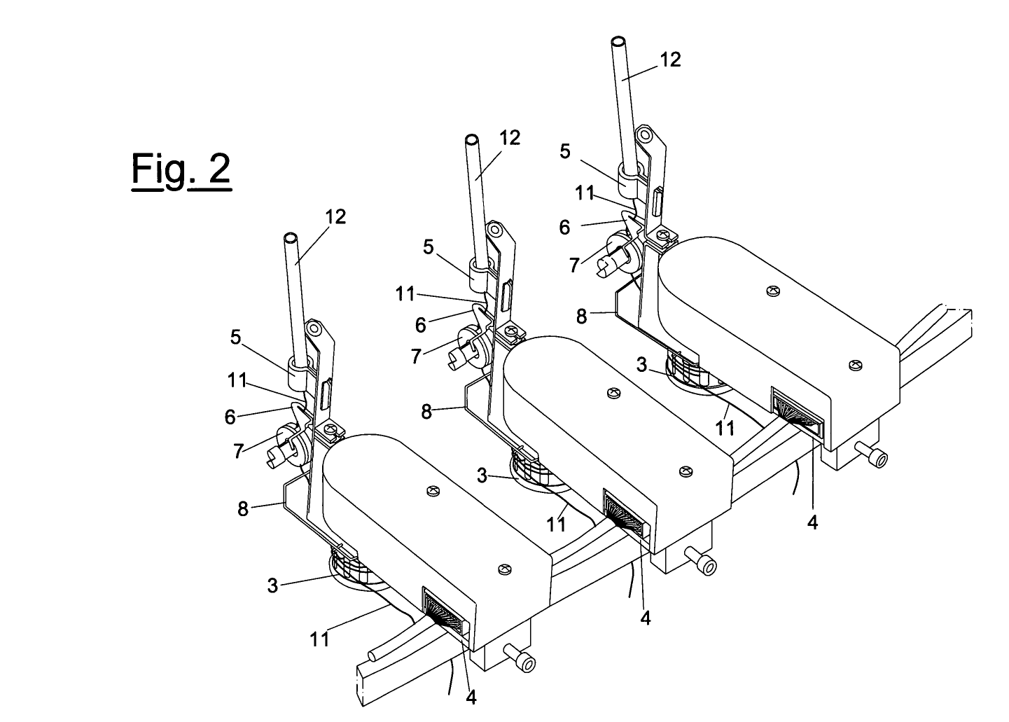

FIG. 2 is a schematic top view of a series of electronic devices for delivering yarn, connected together, according to the invention;

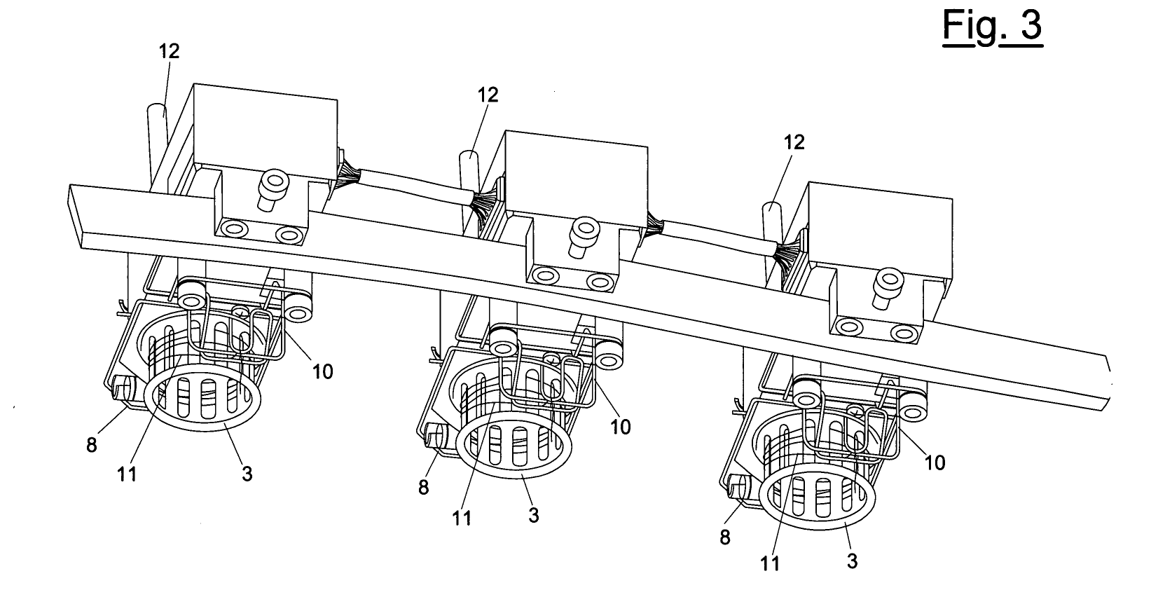

FIG. 3 is a schematic bottom view of the electronic devices of FIG. 2.

With reference to the aforementioned figures, the electronic device for delivering yarn to textile machines, according to the invention, enables adjustment of the delivery of each thread 11 by varying the speed of rotation of a motor 1, so as to maintain said speed of rotation as synchronised as possible, according to an adjustable scale factor, with the speed of the textile machine served.

The electronic device substantially comprises the motor 1 and an electronic control board 2, which includes a microcontroller, which enables the control of rotation speed of the motor 1 and of the currents in the phases of said motor 1.

The electronic device also comprises a yarn-winding wheel 3, fitted onto the shaft of the motor 1 or incorporated directly on the rotating body of said motor 1, as shown in FIG. 1A, said wheel 3 being suitably shaped so as to ensure the correct winding and unwinding of each thread 11; the device also include a pair of small mobile arms, respectively designated by 8 and 10, which are suitable for checking the presence of each thread 11 both at the entrance and at the exit of said yarn-winding wheel 3.

The position of such small arms 8, 10 is detected through “Hall effect” sensors and magnets associated to said small arms 8, 10, while the signals of said sensors and magnets are detected by the microcontroller of the electronic board 2.

The device according to the invention, finally, has a support and attachment plate 4, a support 5 for the yarn-guiding tube 12, a thread-tightener 6, a stopper device 7 and a thread-tightener ring 9.

In particular, in preferred but not limiting embodiments of the present invention it is foreseen to use, as the motor 1, a 12 pole d.c. brushless motor, equipped with “Hall effect” sensors for detecting the position of the rotor placed outside said motor 1.

The control board 2, which comprise the microcontroller, controls a commutation driver of the phases of motor 1 and adjusts the current to be delivered to said motor phases; moreover, the microcontroller reads the analogue signals delivered by the “Hall effect” sensors, which refer to the position of the motor 1, and moreover said microcontroller reads the input frequency signal delivered by an “encoder” device, which is fitted on the rotating cylinder of the textile machine.

Finally, the control board 2 acquires by reading the logical signals delivered by a set of sensors, which can be activated for interrupting the deliver of yarn, and manages an asynchronous serial interface, of the RS485 “half-duplex” type, so as to communicate with the central electronic controller of the textile machine for receiving the configuration parameters, including the synchronism ratio between the delivering speed of the yarn and the rotating speed of the cylinder of the textile machine.

In particular, the microcontroller of the board 2 receives from a buffer of an RS485 serial line the configuration commands and transmits, upon command, the information regarding the current situation, driving the signalling outputs accordingly. The above information is acquired by reading the logic signals coming from a set of sensors for arrest of the yarn or from a manual command for excluding said arrest by reading signals generated by a reference encoder of the textile machine and comparing said signals with the signals coming from the encoder fitted on the shaft of the motor 1.

The electronic device for delivering yarn according to the present invention can finally include an output of an open-collector type, which can be used for remote signalling of a condition of collective arrest, and a set of LEDs for remote display of a state of machine arrest.

By taking into account just the advance pulses, the microcontroller of the board 2 calculates the difference between the number of pulses received from the two encoders, either incrementing or decrementing the count; the instantaneous value totalized by the counter with appropriate corrective factors that can be modified by manual commands issued on the serial line, is used as reference of speed of the analogue and power section.

In addition, the microcontroller of the electronic board 2 sends further commands to the analog section for switching of the phases, said commands being defined according to the dedicated device used for controlling the current in the phases of the d.c. brushless motor 1; in particular, such commands may consist simply of a dynamic brake command issued when it is desired to stop the motor 1 or directly of the commands for enabling the three branches of the power bridge, acquired by the microcontroller by decoding the signals for the position of the rotor of the motor 1 with respect to the stator.

The analogue and power section is made up of a signal portion and a power portion; the signal portion receives the logic signals produced by one or more encoders of the motor 1 and, from these, via a frequency/voltage converter, derives a unidirectional tachimetric signal, of an analogue type, which is compared with the speed reference generated by the microcontroller of the board 2.

In addition, since the motor 1 is a d.c. brushless motor, at each instant it is possible to energize the three windings, so as to obtain advance of the rotor according to the current position thereof; in practice, with the three canonical combinations of use of the winding of the motor 1, which carry out energizing of just two windings at a time, it is possible to exploit a further three intermediate switching combinations, in which, alternately, one winding is connected to the positive side of a supply bus and the other two windings, simultaneously, to the negative side of the supply bus, or vice versa, thus obtaining 6 switches for each pole of the motor, to which there correspond 6 equidistant angular advances of the rotor.

It has already been stated that each electronic device for delivering yarn, according to the present invention, comprises a motor 1, a first encoder for detecting the position of the rotor of said motor 1, which generates the logic control signals, and a local encoder, both of which are fitted on the shaft of the motor 1.

The local encoder may be obtained using a magnetised wheel having a diameter that is compatible with the dimensions of the motor 1 and is equipped with magnetic poles; for reading, pairs of “Hall effect” sensors are preferably used, so as to enable discrimination of the direction of revolution, whilst the signals generated may be the classic channels A, B (signal CHB), or else a clock having a frequency proportional to the r.p.m. of the motor 1 (which reaches a maximum of approximately 10,000 r.p.m.) and a bit for the direction of revolution (signal CHA).

The local encoder may then be eliminated if the logic control signals enable a sufficiently regular movement to be obtained at a low r.p.m. Finally, the electronic device for delivering yarn comprises a local power supply, of a linear type, which enables a reduced voltage for supplying electric power to the control board 2, as well as a possible intermediate voltage for the drivers of the power bridge, to be obtained directly from the supply voltage; the power of the bridge and the value of said intermediate voltage depend upon the characteristics of the dedicated device used for controlling the current in the phases of the brushless motor 1.

Furthermore, an electrolytic capacitor of adequate capacitance provides local coverage of the current peaks absorbed by the motor 1 and initially absorbs the voltage peaks during deceleration, whilst the remaining energy must be absorbed by the d.c. power supply.

As already explained in detail previously, each electronic device for delivering yarn is therefore able to deliver each thread 11 from a single deliver point (knitted yarn) of the textile machine, thus obtaining a synchronism ratio between the speed of the motor 1 (and of the wheel 3) and the speed of the textile machine to be programmed, through the RS485 half-duplex asynchronous serial interface of the control board 2.

Therefore, according to the present invention, each wheel 3 for delivering each thread 11 of the yarn to the textile machine is equipped with the motor 1, which is controlled by the control board 2 and which allows for maintaining the speed of said wheel 3 in synchronism with the speed of the rotating cylinder of the textile machine.

The use of an electronic device according to the invention, which is provided for each thread 11 of the yarn knitted by the machine, thus, enables synchronism among the wheels 3 onto which each thread 11 passes; it is thus possible to program in different ways each device, so as to obtain whatever combination and flexibility of processing, unlike the known systems.

A synchronism ratio may also be reprogrammed when the textile machine is working, so as to obtain programmed sequences of yarn delivering, unlike the traditional systems.

The elimination of transmission belts, with respect to known devices, furthermore, allows the attachment of each device in different positions to those attached to the cylinder of the textile machine.

Finally, in the event of breaking of a single thread 11, it is possible to identify, by means of serial communication, what is the device which has detected the error; in fact, said information can be sent to the central controller of the textile machine, thus quickly allowing the identification of the deliver point that has caused the machine to stop. Also, said information is stored in a memory, so as to detect further possible errors on the same deliver point.

Moreover, the possibility of reprogramming the synchronism ratio, when the machine is working, enables new stitching effects and allows for deactivating the synchronism command on one or more devices, by means of the central controller of the machine; in addition, it is easier to provide for reknitting the yarn after closing the needles' eyes, as compared to known techniques.

In fact, the operation of absorption of yarn by the needles is different from a suitable operation of absorption and therefore it is necessary to have a different synchronism ratio or even to eliminate the control of the motor.

As already stated, the electronic control board 2 of the motor 1 also enables a stop of the machine if the motor 1 has lost its synchronism due to an anomalous tension of the thread 11 entering the wheel 3; this enables detection of friction points of the thread 11 along its path which do not allow a suitable unwinding of the thread 11 from the reel.

The characteristics of the electronic device for delivering yarn to textile machines, which forms the subject of the present invention, as well as the advantages, emerge clearly from the foregoing description.

Finally, it is clear that numerous variations may be made to the electronic device referred to herein, without thereby departing from the principles of novelty inherent in the inventive idea. It is likewise clear that, in the practical implementation of the invention, the materials, shapes and dimensions of the items illustrated may be any whatsoever according to the requirements, and may be replaced with other technically equivalent ones.

1. Electronic device for delivering yarn to textile machines, able to regulate the delivery of yarn by varying the rotating speed of at least one motor (1), so as to maintain said speed as synchronised as possible, according to an adjustable scale factor, with respect to the rotating speed of the textile machine served, characterised in that said device is associated with each yarn-winding wheel (3) for delivering each single thread (11) to the textile machine, said device including said motor (1) and an electronic control board (2) of the motor (1), equipped with at least one microcontroller, which is able to control the rotating speed of the motor (1) and the currents in the phases of said motor (1) and which is able to maintain said rotating speed and, therefore, the delivery speed of the thread (11) synchronous with the rotating speed of the cylinder of the textile machine.

2. Electronic device for delivering yarn according to claim 1, characterised in that said yarn-winding wheel (3) is fitted onto the shaft of the motor (1) and suitably shaped to ensure the correct winding and unwinding of the yarn.

3. Electronic device for delivering yarn according to claim 1, characterised in that said device also comprises a pair of small mobile arms (8, 10), suitable for checking the presence of the thread (11) at the entrance and at the exit of said wheel (3), the position of said arms (8, 10) being detected through sensor means, the signals of which are detected by the microcontroller of the electronic control board (2).

4. Electronic device for delivering yarn according to claim 1, characterised in that said device includes at least one support and attachment plate (4), a support (5) for a yarn-guiding tube (12), a thread-tightener (6), a stopper device (7) and a thread-tightener ring (9).

5. Electronic device for delivering yarn according to claim 1, characterised in that said motor (1) is a d.c. brushless motor, which includes sensor devices for detecting the position of the rotor outside said motor (1).

6. Electronic device for delivering yarn according to claim 3, characterised in that said electronic control board (2) of the motor (1) controls a driver, which switches the phases of the motor (1) and the current to be delivered to said phases, said electronic board (2) being able to detect the signals received from said sensor means and the input frequency coming from a first encoding device, which is engaged with the cylinder of the textile machine, in order to compare said input frequency with the output frequency deriving from a second encoding device fitted onto the shaft of said motor (1).

7. Electronic device for delivering yarn according to claim 6, characterised in that said electronic control board (2) detects the logic signals coming from a set of sensors, which may be activated for interrupting the delivery of yarn, said electronic board (2) being able to manage an asynchronous serial interface for communicating with a central controller of the textile machine, in order to receive a set of configuration parameters, including a synchronism ratio.

8. Electronic device for delivering yarn according to claim 1, characterised in that said device includes at least one output for the remote signalling of a stop condition of the machine and means for displaying said stop condition.

9. Electronic device for delivering yarn according to claim 1, able to deliver thread (11) from a single delivering point of the textile machine, in order to program a synchronism ratio as desired for each electronic device, said. synchronism ratio also being reprogrammable even when the machine is working.

10. Electronic device for delivering yarn according to claim 1, characterised in that said device is fixable in positions different with respect to positions attached to the circumference of the cylinder of the textile machine.

11. Electronic device for delivering yarn according to claim 7, characterised in that said serial interface enables identification and memorisation of the device that has detected the error and the deliver point causing the machine to stop, in the event of breaking of each single thread (11).

12. Electronic device for delivering yarn according to claim 1, characterised in that a synchronism command is deactivable on at least one electronic device, by means of the central controller of the textile machine, so as to ease the reknitting operations of each thread (11) resulting from the closing of the eyes of the needles.

13. Electronic device for delivering yarn according to claim 11, characterised in that said stop of the textile machine is ordered by the electronic control board (2) of the motor (1), in the event that said motor (1) has lost synchronism causing from an anomalous tension of the thread (11) entering the yarn-winding wheel (3), thus identifying friction points of the thread (11), along its path, which do not allow a suitable unwinding of said thread (11) from the reel.
